(19) United States
(12) Patent Application Publication
(10) Pub. No.: US 2005/0133761 A1
(43) Pub. Date: Jun. 23, 2005

(54) Broadband full white reflective display structure

(76) Inventor: Robbie Thielemans, Nazareth (BE)

Correspondence Address: BARNES & THORNBURG, P.O. BOX 2786, CHICAGO, IL, 60690-2786, US

(21) Appl. No.: 10/982,457

(22) Filed: Nov. 5, 2004

Related U.S. Application Data
(60) Provisional application No. 60/531,288, filed on Dec. 19, 2003.

(51) Int. Cl. C09K 19/34

(52) U.S. Cl. 252/299.61

(57) ABSTRACT

The present invention provides a fixed format display panel having a front side and a rear side and comprising a plurality of rows of addressable pixelated reflective light modulating means and at least one longitudinal light guiding structure having at least one emissive light source at at least one of a first and second end. Light coming from the at least one emissive light source is projected across the display panel through the at least one longitudinal light guiding structure and is reflected by said light modulating means through an angle towards the front side.

### TECHNICAL FIELD OF THE INVENTION

The present invention relates to a reflective colour display with improved image quality and methods of driving and manufacturing the same.

### BACKGROUND OF THE INVENTION

Reflective colour displays, such as e.g. LCD displays, are known to suffer from colour shift in function of the viewing angle.

### SUMMARY OF THE INVENTION

It is an object of the present invention to provide a reflective full colour display that has an improved image quality as well as a method of operating and manufacturing the same.

The above objective is accomplished by a method and device according to the present invention.

The present invention provides a fixed format display panel, e.g. a flat panel display. Fixed format display panels comprise a matrix or array of “cells” or “pixels” each producing or controlling light over a small area. The display panel according to the present invention may be described as follows: a display panel having a front side and a rear side, the panel comprising:
a plurality of rows of addressable pixelated reflective light modulating means,
at least one longitudinal light guiding structure having at least one emissive light source at at least one of a first and second end,
   whereby light coming from said at least one emissive light source is projected across the display panel through said at least one longitudinal light guiding structure and is reflected by said light modulating means through an angle towards the front side. The display can display an arbitrary image by suitable addressing of the addressable pixelated reflective light modulating means.

Said at least one longitudinal light guiding structure may have a coating such that light coming from said at least one emissive light source is either internally reflected or guided towards the plurality of light modulating means.

For each row of light modulating means a longitudinal light guiding structure may be provided.

The longitudinal light guiding structure may comprise an optical fibre or a light pipe array.

The display panel may comprise at least one emissive light source at the first end and a reflector at the second end. Alternatively, the display panel may comprise at least one emissive light source at the first end and at least one emissive light source at the second end.

Each emissive light source may comprise at least one LED. Each emissive light source may comprise a monochrome LED or a combination of LEDs providing a full-colour light source, for example three monochrome LEDs respectively emitting light of three primary colours such as e.g. red, green and blue, and wherein each emissive light source is driven in accordance with field-sequential colour emission.

The reflective light modulating means may be an iMoD reflective display.

A display panel according to an embodiment of the present invention may further comprise means for driving the combination of LEDs providing a full-colour light source driving and the light modulating means, so that a full-colour image is displayed by field sequential colour display.

In a second aspect, the present invention provides a method for displaying an image onto a display, the display having a front side and a rear side, and
a light panel with a plurality or rows of light modulating means,
at least one longitudinal light guiding structure connected to said light panel and having at least one emissive light source at at least one of a first and second end, the method comprising:
driving said light modulating means in accordance with the image to be displayed,
guiding light into and through said at least one longitudinal light guiding structure across the panel, and
reflecting said light onto the said modulating means, whereby light coming from said at least one emissive light source is reflected through an angle towards the front side by said light modulating means. The image may be any arbitrary image.

In the method, when each emissive light source comprises three or more monochrome LEDs respectively emitting light of three or more primary colours, e.g. red, green and blue, driving said light modulating means and said three or more monochrome LEDs may be coordinated so that image is displayed by field sequential colour emission.

A third aspect of the present invention includes a manufacturing method for manufacturing a display with the above characteristics.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIGS. 1a and b show a side elevation cross-section and a top view of a display in accordance with an embodiment of the present invention, respectively.

FIGS. 2a and b show a cross-sectional view and a top view of another embodiment of the present invention, respectively.

FIG. 3 is a schematic cross-sectional view of a polarisation based reflective display structure according to an embodiment of the present invention.

FIG. 4 and FIG. 5 are a three-dimensional view and a cross-sectional view respectively of a reflective display structure using optical fibres according to an embodiment of the present invention.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

The present invention provides a reflective monochromatic or full colour display.

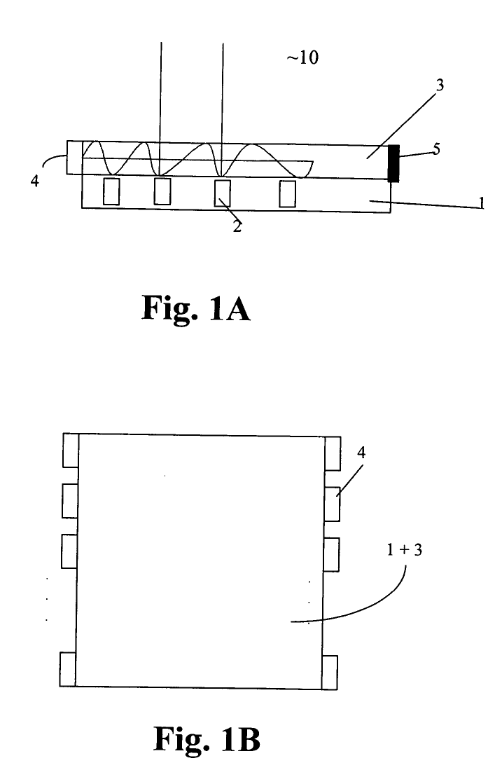

FIG. 1 illustrates a display 10 according to a preferred embodiment of the present invention. The display 10 comprises a reflective optoelectronic device 1, which may for example be a digital mirror display (DMD) or an interferometric modulator (iMoD) or a reflective liquid crystal display (LCD). The reflective optoelectronic device 1 comprises addressable elements. For example, the reflective optoelectronic device 1 comprises a plurality of rows of pixelated light modulating means 2 which may for example be digital mirror devices or liquid crystal cells. At least one light guiding structure 3 is connected to the reflective optoelectronic device 1. In this preferred embodiment of the invention a plurality of light guiding structures 3 may be provided. The light guiding structures 3 in this embodiment may comprise for example optical fibres or other forms of light pipes. Each light guiding structure 3 comprises a first and a second end and has at least one emissive light source 4 at at least one of the first or second end. In the preferred embodiment of FIG. 1, an emissive light source 4 is provided at one end of the light guiding structure 3 and a reflector 5 is provided at the second end of the light guiding structure 3. The emissive light source 4 may for example comprise a full colour light emitting diode (LED), a monochrome LED or several monochrome LEDs respectively emitting light of the primary colours, e.g. red, green and blue or other combinations of primary colours which, in combination, can form white light. It is advantageous for the device according to the present invention if the emissive light sources emit a narrow spectrum of each primary colour. In the latter case, thus when 3 monochrome LEDs are used which respectively emit red, green or blue, and the red, green and blue information for each light modulating means is presented simultaneously but through elements that are physically separated, it is said to be employing the spatial colour type. The three primary-colour images are presented such that the eye sees them simultaneously, occupying the same image plane and location, and so the appearance of a full-colour image results. However, it is preferred to present the three primary-colour images in the same location but separated in time. For example, the red image might be seen first, then the green, and then the blue. If this sequence is repeated rapidly enough, the eye cannot distinguish the separate colour images, which are also called fields, and again perceives a single full-colour image. This is referred to as a sequential colour display system, or sometimes as field-sequential colour type. Obviously, the interface requirements for the two are considerably different. In the spatial-colour types, the information for the red, green, and blue values for each light modulating means 2 must be transmitted essentially simultaneously, or at least sufficiently close in time such that the display can recover all three and present them together.

The light guiding structure 3 is used to guide the light from the emissive light source 4 to the reflective optoelectronic device 1, so that the light from the emissive light source 4 reflects on the reflective optoelectronic device 1, e.g. on the pixelated light modulating means 2. An appropriate means (not shown in the figure) can furthermore be used to couple the light from the emissive light source 4 into the light guiding structure 3. To make sure that the light coming from the emissive light source 4 and sent into the light guiding structure 3, does not immediately leave the light guiding structure 3, the light guiding structure 3 may be provided with a coating, in such a way that light coming from the emissive light source 4 is either internally reflected in the light guiding structure 3 or guided towards the light modulating means 2, and that light coming from the emissive light source 4 and being reflected by the light modulating means 2 in a direction substantially perpendicular to the plane of the reflective optoelectronic device 1 is sent out of the light guiding structure 3.

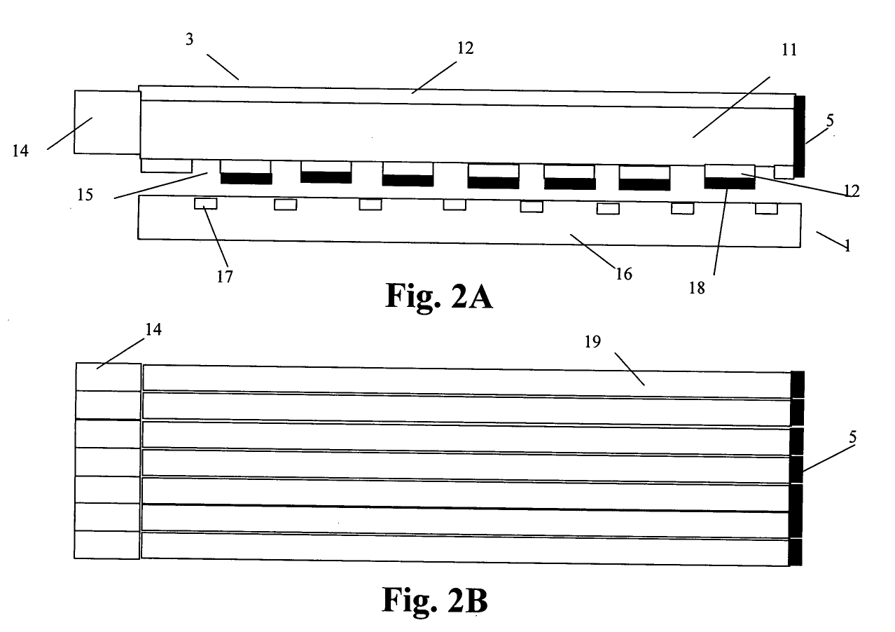

FIG. 2a shows a cross-section through a specific embodiment of the present invention. It comprises a light guiding structure 3 and a reflective optoelectronic device 1. The light guiding structure 3 has a core 11 of transparent material, such as e.g. glass. The core 11 of transparent material may be, but does not need to be, covered by a transparent coating 12, for example to get rid of ambient light. The coating 12 may be present at the bottom side of the light guiding structure 3 only. The material of the core 11 and the coating 12 or cladding material preferably are optically clear but have widely differing refractive indices so as to obtain the internal reflection. It is known that, the higher the difference in refractive indices of core 11 and coating 12, the higher the angle of incidence of light from the emissive light source 14 which adds to the total internal reflection. The light guiding structure 3 is represented in the drawings to be rectangular in cross-section. For a volume that is rectangular in cross-section, when TIR occurs on the top surface, it will also occur on the bottom surface since it is rectangular. As a result, the light that does not leave the light guiding structure directly but is reflected back through TIR on the top surface will also reflect back through TIR on the bottom surface and will therefore never leave the light guiding structure. In particular for this reason, the layout of the light guiding structure is not restricted to such volume that is rectangular in cross-section, but it can have any other suitable shape. In particular it may be provided with an inclination on the top surface so as to change the angle of incident radiation on the bottom surface of the light guide, so that the possibility that the ray exits the light guide through the bottom surface increases, the radiation no longer being restricted to total internal reflection by changing the angle of incident radiation. Other suitable shapes of the light guiding structure 3 may also be used. Alternatively, a light guiding structure 3 which is rectangular in cross-section or has any other suitable shape, may be provided with surface structures to enable light to be coupled out from the light guiding structure 3. Such surface structures may for example be painted or sand-blasted dots. In an alternative embodiment the surface structure may comprise e.g. pyramidal structures with a wide opening angle so as to not couple out light immediately, or an etched surface.

In the embodiment illustrated in FIG. 2a, at selected places 15 on the rear side of the light guiding structure 3, i.e. on that side of the light guiding structure 3 away from a viewer, the coating 12 or cladding is removed so as to extract light from the light guiding structure 3. These positions are arranged to coincide with the active reflective regions 17 of the reflective optoelectronic device 1, e.g. a reflective light modulating device such as a DMD, an iMoD or an LCD. Where the coating 12 has been removed, light from within the core 11 exits the core 11 and is reflected towards the front of the display, i.e. towards a user. Due to the fact that the active reflective regions can be oriented in such a way that the reflected light travels under an angle which equals nearly 90° to the coating 12 and the core 11, there is no internal reflection and the light exits from the front of the display. The active regions 17 of the reflective optoelectronic device 1 may have two positions, a first position in which light exiting from the core 11 is projected forwards, i.e. towards a user of viewer, and a second position in which the light is reflected in another direction so that it cannot be seen. For example, black light absorbing sections 18 may be provided on the coating 12 in between the openings 15, for absorbing light exiting from the core 11 and reflected in the second direction.

As seen in FIG. 2b, the light guiding structure 3 comprises a large number of light guides 19 arranged in parallel so that rows of a active regions 17 of the reflective optoelectronic device 1 can be provided with light. Each of these light guides 19 may be provided by a conventional optical fibre with cladding. The cladding is locally removed from the core 11 to provide the openings 15.

The reflective optoelectronic device 1 is designed in such a way that it reflects full white light, i.e. broadband full white light, at any and every angle. Colour shifts are not preferred and are best avoided. The amount of reflected light may be modulated on a pixel-by-pixel basis by, e.g. movement of reflective elements or by changes in filtering/opacity properties.

The present invention furthermore provides a method for displaying an image onto a reflective display according to this invention. The method comprises the following subsequent steps.

In a first step, the light modulating means 2 of a reflective optoelectronic device 1 are driven in order to set the light modulating means 2 to a predetermined position depending on the image that is to be displayed. Light coming from an emissive light source 4 is coupled in into the light guiding structure 3 and is guided so as to reflect onto the light modulating means 2. The light that has been reflected on the light modulating means 2 is then either reflected in a direction substantially perpendicular to the plane of the reflective optoelectronic device 1 or absorbed by the light modulating means 2. Whether the light is reflected or absorbed depends on the predetermined position of the light modulating means 2, and thus on the image to be displayed. In a last step, the light reflected by the light modulating means 2 in a direction substantially perpendicular to the plane of the reflecting display is coupled out the light guiding structure 3 for making it available to the viewer.

From the above certain aspects of the present invention will be understood. Several emissive light sources are placed at the side of a reflective display, e.g. an iMoD reflective display. The emissive light sources can e.g. be several full colour LEDs (or several monochrome LEDs respectively emitting light of primary colours, e.g. Red, Green, and Blue). It is an advantage that the emissive light sources emit a narrow spectrum of each primary colour. The reflective display is designed in such a way that it reflects full white, i.e. broadband full white under every angle. The amount of reflected light can be modulated on a pixel-base.

A light guiding structure is used to guide the light from the e.g. LEDs to the reflective display, so that the light from the LEDs reflects on the reflective display. An appropriate means is used to couple the light from the LEDs into the light guiding structure. A light pipe array or other optical element array may be used in combination with the light guiding structure in order to couple the light out of the display and at the meanwhile having control over the light distribution that is realised in function of the viewing angle and the contrast ratio.

In order to form a full colour image, firstly the red LEDs are lit and the display is driven in such a way that the appropriate amount of red light is reflected on the appropriate pixels of the reflective display. Secondly, the blue LEDs are lit and the display is driven in such a way that the appropriate amount of blue light is reflected on the appropriate pixels of the reflective display. Finally, the green LEDs are lit and the display is driven in such a way that the appropriate amount of green light is reflected on the appropriate pixels of the reflective display. Thus, a field sequential colour technique is used.

Optical coatings (e.g. an anti-reflection or anti-glare coating) and/or films (e.g. as diffusing film) can be applied to the optical element array.

The edges of the reflective display elements can be coated with an appropriate coating (e.g. an anti-reflection coating or a reflective coating) in order to improve the image quality.

A very important advantage of using emissive light sources e.g. full colour or monochrome LEDs (with a narrow spectral emission) as an illuminator of the reflective displays, is that there can not occur a colour shift in function of the viewing angle: if one wants to generate the red part of the image, only the red LEDs will be lit. Since there is only red light available, no wavelength shift in function of the viewing angle can occur. The same reasoning can be done for the blue and the green light.

The ambient reflected light can still give a colour shift in function of viewing angle. However, if the amount of light reflected from the LEDs exceeds the ambient reflected light, the colour shift created by the ambient light will be very small or even negligible. Another possibility is that the optical element array placed on top of the light guiding structure is designed in such a way that it minimises the colour shift in function of viewing angle caused by the ambient light. It is also possible to include an additional optical element or optical film in order to control the reflected ambient light.

Another advantage of the invention described in this disclosure is that it allows producing high resolution full colour displays since the same pixels can be used to reflect the red, blue and green light. This eliminates the need for having red, green, and blue sub-pixels within a pixel.

The number of emissive light sources that is used to illuminate the reflective display can be made dependent on e.g. pixel pitch, ambient illumination level, reflectivity of the reflective display, required image quality, etc.

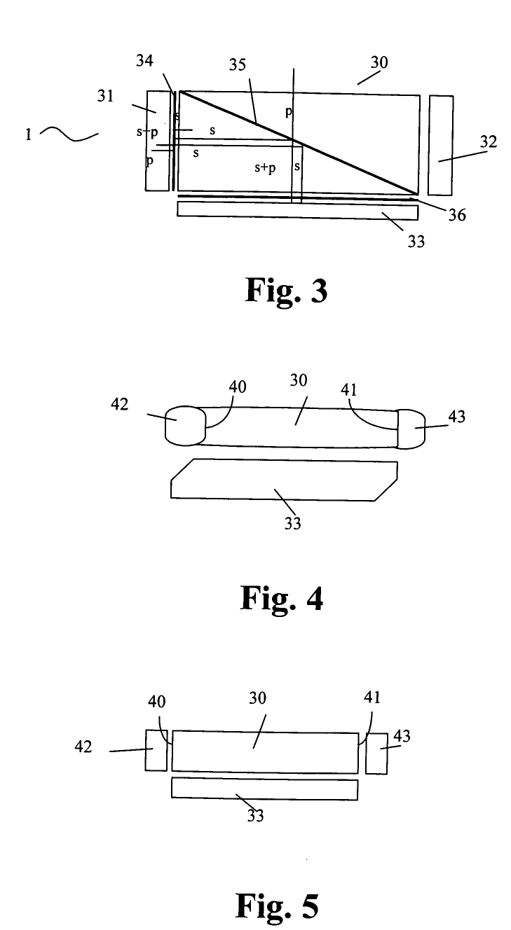

A first example of a broadband full white reflective display structure is given hereinafter, with respect to FIG. 3, which illustrates a polarisation based reflective display structure. It comprises a light guiding structure 30, an emissive light source 31, e.g. a LED array, an optional reflective element 32 and pixelated light modulating means 33. The light guiding structure 30 preferably is made of optical transparent bulk material. A first polariser element 34 is present between the emissive light source 31 and the light guiding structure 30. This first polariser element 34 preferably is a reflective polariser, which transmits light having a first polarisation direction, e.g. the s-polarisation, and reflects light having a second polarisation direction, e.g. the p-polarisation, the first and the second polarisation directions being orthogonal with respect to each other. In the light guiding structure 30, and placed under a non-zero angle with respect to the first polariser element 34, is placed a second polariser element 35. This second polariser element 35 preferably is a reflective polariser, which transmits light having the second polarisation direction, e.g. p-polarisation, and reflects light having the first polarisation direction, e.g. s-polarisation. A diffuser element 36 is provided in between the light guiding structure 30 and the pixelated light modulating means 33.

If the emissive light source 31 emits randomly polarised light, i.e. light comprising both the first and the second polarisation directions, then the light emitted from the light source 31 falls in onto the first polariser element 34, where the part of the light having the first polarisation direction is transmitted and coupled into the light guiding structure 30. The part of the light emitted by the light source 31 and having the second polarisation direction is reflected by the first polariser element 34, back towards the emissive light source 31. The part of the light which was coupled into the light guiding structure 30 falls in onto the second polariser element 35, where it is reflected towards the pixelated light modulating means 33. When leaving the light guiding structure 30, this light, having the first polarisation direction, passes through the diffuser element 36, thus losing its polarisation direction, or thus becoming randomly polarised light again. This randomly polarised light falls in onto the light modulating means 33, where it is reflected towards the front end, of the reflective display device 1, i.e. the side looked at by a viewer. This light, after again having passed through the diffuser element 36, enters the light guiding structure 30 and falls in onto the second polariser element 35, where it is split into light having the first polarisation direction and light having the second polarisation direction. The light having the first polarisation direction is reflected by the second polariser element 35, and the light having the second polarisation direction is transmitted by the second polariser element 35, and can leave the display 1, thus presenting an image to a viewer. The reflected light is reflected back to the first polariser element 34, where it is reflected back towards the second polariser element and so on.

Optionally, the device as described above may comprise a reflective element 32. Ambient light entering the light guiding structure 30 from the front side, i.e. from the viewing side of the display 1, is split into light having the first polarisation direction and light having the second polarisation direction, upon hitting the second polariser element 35. The light having the first polarisation direction is reflected by the second polariser element 35 towards the reflective element 32, while the light having the second polarisation direction is transmitted towards the light modulating means 33, which it hits after having passed through the diffuser element 36. The light reflected from the light modulating means 33 is randomly polarised, and splits, upon impinging onto the second polariser means 35, into light having a first polarisation direction and light having a second polarisation direction, the light having the first polarisation direction being reflected towards the first polariser element 34 and the light having the second polarisation direction being transmitted through the second polariser element 35 towards the viewer.

Since the above design is polarisation dependent, the efficiency of this design significantly increases when the emissive light source 31 emits suitably polarised light, as in that case less light is lost upon impinging on the first polariser element 34.

In a preferred embodiment, not represented in the drawings, a further reflective element, e.g. a mirror, can be placed at the back of the emissive light source 31 so as to recycle the light reflected back at the first and second polariser elements 34, 35.

A further example of a broadband full white reflective display according to the present invention is given hereinafter, and is explained referring to FIG. 4 and FIG. 5. The reflective optoelectronic device 1 represented in these drawings comprises a light guiding structure 30 under the form of an optical fibre with bulk scattering, the optical fibre having a first and a second longitudinal end 40, 41. The light guiding structure 30 is provided adjacent pixelated light modulating means 33. A first emissive light source 42 and a second emissive light source 43 are provided at either longitudinal end 40, 41 of the light guiding structure 30. Light emitted from the first emissive light source 42 and coupled in longitudinally into the light guiding structure 30 at its first longitudinal end 40 is scattered in the bulk of the optical fibre in all directions, and may leave the optical fibre towards the pixelated light modulating means 33 where it is reflected and out coupled at the front side, i.e. towards a viewer. The light guiding structure 30 thus forms a means for substantially changing the propagation direction of the incoupled light, i.e. changing it over an angle between about 70 and 1100.

In a physical display a series of optical fibres as represented in FIG. 4 should be placed on top of the pixelated light modulating means 33. For reasons of simplicity, only one single optical fibre is illustrated in FIG. 4 when illustrating the concept.

Depending on the size of the light modulating means 33, it may be advantageous to use light sources 42, 43 at one or at both sides of the light guiding structure 30. Placing light sources 33 at both sides of the light guiding structure 30 increases the uniformity of illumination of the light modulating means 33, and therefore increases the image quality.

It is to be understood that although preferred embodiments, specific constructions and configurations, as well as materials, have been discussed herein for devices according to the present invention, various changes or modifications in form and detail may be made without departing from the scope and spirit of this invention. For example other optical structures than the ones described can be designed.

1. A display panel having a front side and a rear side, the display panel comprising:
a plurality of rows of addressable pixelated reflective light modulating means,
at least one longitudinal light guiding structure having at least one emissive light source at at least one of a first and second end,
whereby light coming from said at least one emissive light source is projected across the display panel through said at least one longitudinal light guiding structure and is reflected by said light modulating means through an angle towards the front side.

2. A display panel according to claim 1, wherein said at least one longitudinal light guiding structure has a coating such that light coming from said at least one emissive light source is either internally reflected in the light guiding structure or guided towards the plurality of light modulating means.

3. A display panel according to claim 1, wherein for each row of light modulating means a longitudinal light guiding structure is provided.

4. A display panel according to claim 1, wherein the longitudinal light guiding structure comprises an optical fibre.

5. A display panel according to claim 1, wherein the at least one longitudinal light guiding structure comprises a light pipe array.

6. A display panel according to claim 1, the display panel comprising at least one emissive light source at the first end and a reflector at the second end.

7. A display panel according to claim 1, the display panel comprising at least one emissive light source at the first end and at least one emissive light source at the second end.

8. A display panel according to claim 1, wherein each emissive light source comprises at least one LED.

9. A display panel according to claim 8, wherein each emissive light source comprises a monochrome LED or a combination of LEDs providing a full-colour light source.

10. A display panel according to claim 9, wherein each emissive light source comprises three monochrome LEDs respectively emitting light of three primary colours, and wherein each emissive light source is driven in accordance with field-sequential colour emission.

11. A display panel according to claim 1, wherein the reflective light modulating means is an iMoD reflective display.

12. A display panel according to claim 9, further comprising means for driving the combination of LEDs providing a full-colour light source and said light modulating means, so that a full-colour image is displayed by field sequential colour display.

13. A method for displaying an image onto a display, the display having a front side and a rear side, and
a light panel with a plurality or rows of light modulating means,
at least one longitudinal light guiding structure connected to said light panel and having at least one emissive light source at at least one of a first and second end,
the method comprising:
driving said light modulating means in accordance with the image to be displayed,
guiding light into and through said at least one longitudinal light guiding structure across the panel, and
reflecting said light onto the said modulating means, whereby light coming from said at least one emissive light source is reflected through an angle towards the front side by said light modulating means.

14. The method according to claim 13, each emissive light source comprising three monochrome LEDs respectively emitting light of three primary colours, wherein driving said light modulating means and said three monochrome LEDs is co-ordinated so that image is displayed by field sequential colour emission.
